(19) United States
(12) Patent Application Publication
(10) Pub. No.: US 2010/0304061 A1
(43) Pub. Date: Dec. 2, 2010

(54) FABRICATION OF HIGH ASPECT RATIO FEATURES IN A GLASS LAYER BY ETCHING

(75) Inventors: Winnie N. Ye, Ottawa (CA); Kenneth B. Crozier, Cambridge, MA (US); Peter Duane, Waltham, MA (US); Munib Wober, Topsfield, MA (US)

Correspondence Address: PILLSBURY WINTHROP SHAW PITTMAN, LLP, P.O. BOX 10500, MCLEAN, VA, 22102, US

(73) Assignees: ZENA TECHNOLOGIES, INC., Cambridge, MA (US); PRESIDENT AND FELLOWS OF HARVARD COLLEGE, Cambridge, MA (US)

(21) Appl. No.: 12/472,271

(22) Filed: May 26, 2009

(51) Int. Cl. B32B 1/08; C23F 1/00; B32B 3/10; B32B 3/00

(52) U.S. Cl. 428/34.4; 216/24; 428/156; 428/141

(57) ABSTRACT

Methods, apparatuses, systems, and devices relating to the fabrication of features for semiconductor devices are disclosed. The features may include vias and pillars. In some implementations, the vias may define light pipes for semiconductor image sensor devices that serve to guide electromagnetic radiation directly down to photodiodes or other radiation detecting elements formed on an underlying silicon substrate. These structures significantly improve the light collection efficiency and reduce the scattering and crosstalk losses in the dielectric layer. An etch mask may be used to produce features through a subsequent etching process. More specifically, the etch mask defines sidewalls in the glass layer, provides excellent dry etch resistance, and enables easy lift-off of the etch mask from the glass layer. Two embodiments are disclosed herein: the first using amorphous silicon as the etch mask; and the second employing a photoresist as the etch mask. Both embodiments produce high aspect ratio features having generally vertical and smooth sidewalls.

### FIELD

This application generally relates to semiconductor manufacturing, and in particular, the fabrication of high aspect ratio features in a glass layer by etching.

### BACKGROUND

Complementary metal-oxide semiconductor (CMOS) image sensors are increasingly being used in the commercial market due to their ease of integration, low cost and reduced power consumption.

An image sensor may be fabricated to have a large number of identical sensor elements (pixels), generally more than 1 million, in a (Cartesian) square grid. The pixels may be photodiodes, or other photosensitive elements, that are adapted to convert electromagnetic radiation into electrical signals. However, as the pixel size decreases, the imager's sensitivity is reduced and crosstalk among pixels is increased.

Today, the predominant type of photodiodes (PDs) are built on planar technology by a process of etching and depositing a number of layers of oxides of silicon, metal and nitride on top of crystalline silicon. The PN-junction is constructed as a plurality of layers on a substrate giving a device with an essentially horizontal orientation. The light-detection takes place in a subset of these layers.

Light pipes have been introduced into solid state image devices to confine and transmit electromagnetic radiation impinging thereupon to the photosensitive elements. While etching vertical features in silicon and other crystalline materials may be performed using conventional etching techniques, etching features in amorphous materials, such as dielectric glasses, has not been successfully performed having a high aspect ratio and/or verticality.

### SUMMARY

According to an embodiment, a method for fabricating a feature in a 10 μm or thicker glass layer comprises: forming a silicon etch mask on the glass layer; and etching a sidewall in the glass layer to form a feature having a depth or height and a width, wherein the features has an aspect ratio of at least about 3.0:1, the aspect ratio being the ratio of the depth or height to the width.

According to an embodiment, a method for fabricating a feature in a glass layer comprises: forming a photoresist etch mask on the glass layer; and etching a sidewall in the glass layer to form a feature having a depth or a height and a width, wherein the feature has an aspect ratio of at least about 3.0:1, the aspect ratio being the ratio of the depth or the height to the width.

According to another embodiment, a device comprises a layer of glass having a feature having a depth or a height and a width, wherein the feature has an aspect ratio of at least about 3.0:1, the aspect ratio being the ratio of the depth or the height to the width, and a sidewall angle of at least about 87°.

Preferably, the glass comprises silica, fused quartz, silicon dioxide (SiO₂) or borophosphosilicate glass.

Preferably, the feature is a via, and further comprises filing the via with a high refractive index material. Preferably, the high refractive index material comprises silicon nitride (SiN).

The methods could further comprise performing a planarization process to remove an excess top coating of the high refractive index material; and optionally, depositing an additional high refractive index material in the via.

Preferably, the feature has a sidewall having a sidewall angle of about at least 87°.

Preferably, the etching comprises reactive ion etching (RIE) comprising flowing the one or more gases.

Preferably, the feature has a sidewall having a sidewall surface roughness (σ_{RMS}) of about 10 nm or less.

Preferably, the feature is one of a via or a pillar.

Preferably, the forming the silicon etch mask comprises depositing approximately a 1.5 to 2.5 μm thick amorphous silicon layer on the glass layer.

The methods could further comprise depositing approximately a 50 to 200 nm layer of silicon nitride (SiN) on the glass layer before depositing the amorphous silicon layer.

The methods further comprise depositing approximately a 5 to 7 μm photoresist layer on the amorphous silicon etch mask.

The methods could further comprise depositing approximately a 5 to 10 nm layer of hexamethyldisilazane (HMDS) on the amorphous silicon etch mask before depositing the photoresist layer.

Preferably, the gases used for etching could include CF₄ at approximately 2 to 5 sccm; CHF₃ at approximately 50 sccm or higher; H₂ at approximately 25 sccm or higher; Ar at approximately 5 to 7 sccm; and O₂ at approximately 0 sccm or 7 to 9 sccm for the silicon etch mask or the photoresist etch mask, respectively, each at a pressure of approximately 1.9 to 2.5 mTorr.

Preferably, the O₂ is periodically flowed for 5 minutes during said gas flowing approximately every 20 minutes.

Preferably, the forming the photoresist etch mask comprises forming a negative photoresist etch mask.

Preferably, the photoresist etch mask is approximately 5 to 7 μm thick.

Preferably, the feature has an aspect ratio of at least about 5.8:1.

Preferably, the aspect ratio is about at least 7.2:1 and the sidewall angle is about at least 87.4°.

Preferably, the aspect ratio is about at least 6.7:1 and the sidewall angle is about at least 89.5°.

Other features of one or more embodiments of this disclosure will seem apparent from the following detailed description, and accompanying drawings, and the appended claims.

### BRIEF DESCRIPTION OF THE DRAWINGS

Embodiments of the present disclosure will now be disclosed, by way of example only, with reference to the accompanying schematic drawings in which corresponding reference symbols indicate corresponding parts, in which:

FIG. 1 illustrates a schematic of the fabrication process of a silicon etch mask in accordance with an embodiment;

FIG. 2 illustrates a schematic of the fabrication process of a negative photoresist etch mask in accordance with an embodiment;

FIG. 3 illustrates a schematic of reactive ion etching system which may be used in accordance with the embodiments herein, in which FIG. 3(a) shows a schematic of the etching gases that may be supplied to the etching system;

FIGS. 4(a)-(d) are scanning electron microscope (SEM) images showing cross-sections of the high aspect ratio vias which were fabricated using an etch recipe in accordance with an embodiment;

FIGS. 5(a)-(d) are SEM images showing cross-sections of the high aspect ratio vias which were fabricated using an etch recipe in accordance with an embodiment;

FIG. 6 is a SEM image showing a partial lift-off process of a silicon etch mask in accordance with an embodiment;

FIG. 7 is a SEM image showing a topographic view of a sample after the removal of the photoresist etch mask in accordance with an embodiment;

FIG. 8 is a SEM image showing uniform sidewall coverage after a PECVD deposition of SiN in a via;

FIGS. 9(a)-9(c) are SEM images showing a via filled with SiN in accordance with an embodiment, in which FIG. 9(a) shows the light pipe after 3 hours of the PECVD deposition of SiN, FIG. 9(b) shows planarization of the top portion of the via within 5 minutes of a SiN etch, and FIG. 9(c) shows the via after an additional 30 minutes of PECVD deposition of SiN; and

FIG. 10 is an SEM image showing circular vias which were fabricated in accordance with an embodiment;

FIGS. 11(a)-11(c) are SEM images showing circular pipes filled with SiN in accordance with an embodiment, in which FIG. 11(a) shows the light pipe as etched (prior to the PECVD deposition of SiN), FIG. 11(b) shows the pipe after 3 hours of the PECVD deposition of SiN, FIG. 11(c) shows the circular pipes after planarization with 10 minutes of a SiN RIE etch, followed by an additional 40 minutes of PECVD deposition. FIGS. 11(d) and 11(e) compare the cross-sections of the circular pipes before and after the SiN PECVD filling process; and

FIGS. 12(a) and 12(b) are SEM images showing circular pillars which were fabricated in accordance with an embodiment; and

FIG. 13 shows an isometric view of an exemplary image sensor device in accordance with an embodiment.

### DETAILED DESCRIPTION

In the following detailed description, reference is made to the accompanying drawings, which form a part thereof. In the drawings, similar symbols typically identify similar components, unless the context dictates otherwise. The illustrative embodiments described in the detail description, drawings, and claims are not meant to be limiting. Other embodiments may be utilized, and other changes may be made, without departing from the spirit or scope of the subject matter presented here.

This disclosure is drawn to, among other things, methods, apparatuses, systems, and devices relating to the fabrication of one or more features in a dielectric glass layer by etching. The features may include one or more of vias and/or pillars. In some embodiments, the vias may define light pipes for a semiconductor image sensor device, although it will be appreciated that the feature fabrication embodiments disclosed herein may have other applications for semiconductor device fabrication, in which vias and pillars may be desired. Thus, any disclosure of light pipes is not intended to be limiting to the via fabrication processes.

A “light pipe,” as used herein, is an optical device for confining and transmitting electromagnetic radiation over its length. The light pipe may be circular or non-circular in cross-section. As discussed above, light pipes may be used in solid state image sensor devices to confine and transmit electromagnetic radiation impinging thereupon to the photosensitive elements or other radiation detecting elements formed on an underlying substrate layer. The image sensor may be configured to detect electromagnetic radiation, such as infrared (IR), visible, and/or ultraviolet (UV) light. These structures may significantly improve the light collection efficiency and reduce the scattering and crosstalk losses in the dielectric layer.

According to an embodiment, one or more features, such as vias or pillars, may be formed in a dielectric glass layer to define one or more light pipes. The dielectric glass layer may be formed upon a wafer or substrate, for example, comprised of crystalline silicon.

The thickness of the glass layer could be in the range of 10 nm to about 500 μm as the reactive ion etching of the embodiments herein applies to all thicknesses from 10 nm to 500 um range.

The features may be fabricated by an etching process using an etch mask as a template or pattern using contact lithography. More specifically, the etch mask defines the sidewalls of the features, provides excellent dry etch resistance, and/or enables an easy lift-off process on the etch mask from the dielectric glass layer. At least two embodiments for fabricating features are disclosed herein: the first using amorphous silicon as the etch mask; and the second employing a photoresist as the etch mask. Both embodiments produce high aspect ratio features, having generally vertical and smooth sidewalls. Additional embodiments could be combinations of the features of using amorphous silicon as the etch mask and a photoresist as the etch mask.

The term “aspect ratio,” as used herein, may be defined as the ratio of the depth or the height of a particular feature to its width (or diameter). For example, according to the embodiments herein, features may be produced having a high aspect ratio of at least about 3:1, and more preferably greater than about 7.0:1. The sidewalls of features be fabricated to have high verticality and smoothness, for instance, with each sidewall having a sidewall angle at least 87°, and more preferably greater than about 87°, and having a sidewall surface roughness (σ_{RMS}) of about a few nanometers, preferably 20 nanometers or less. As such, smooth, clean high aspect ratio features may be produced, which are substantially free of debris.

The aspect ratio could be from about 3:1 to about 25:1 depending on the thickness of the glass layer and the photolithography method used for forming the etch mask on the glass layer. The aspect ratio could be about 3:1, 4:1, 5:1, 6:1, 7:1, 8:1, 9:1, 10:1, 11:1, 12:1, 13:1, 14:1, 15:1, 16:1, 17:1, 18:1, 19:1, 20:1, 21:1, 22:1, 23:1. 24:1 and 25:1.

The photolithography methods could be optical lithography, electron beam lithography, X-ray lithography, extreme ultraviolet lithography, ion projection lithography, and immersion lithography.

Optical lithography is a process used in micro fabrication to selectively remove parts of a thin film or the bulk of a substrate. It uses light to transfer a geometric pattern from a photo mask to a light-sensitive chemical photo resist, or simply “resist” on the substrate. Electron beam lithography (often abbreviated as e-beam lithography) is a form of maskless lithography in which a beam of electrons in a patterned fashion across a surface covered with a resist, exposing the resist and selectively removing either exposed or non-exposed regions of the resist (“developing”). The purpose, as with photolithography, is to create very small structures in the resist that can subsequently be transferred to the substrate material, often by etching.

The ability to project a clear image of a small feature onto a wafer using a mask is limited by the wavelength of the light that is used, and the ability of the reduction lens system to capture enough diffraction orders from the illuminated mask. Photolithography tools could use deep ultraviolet (DUV) light with wavelengths of 248 and 193 nm, which allow minimum feature sizes down to 50 nm. E-beam lithography and other alternatives to optical lithography could allow minimum feature size down to one or few nanometers.

In one implementation, the features may be vias. The vias may be circular in cross-section, although they may include trenches (i.e., linear slots having a large length to width ratio). Other shaped vias are also possible. For example, vias formed in accordance with the disclosed embodiments may be approximately 1.5 μm in width/diameter and have a depth of about 10.8 μm, with an aspect ratio of 7.2:1.

In another implementation, the features may be pillars. The pillars may be circular in cross-section, although other shaped pillars are also possible. For example, vias formed in accordance with the disclosed embodiments may be approximately 2.4 μm in width/diameter and have a height of about 13.88 μm, with an aspect ratio of 5.8:1.

The dielectric glass layer may include silica, fused quartz, silicon dioxide (SiO₂), or other the like suitable for semiconductor device fabrication. Borophosphosilicate glass (BPSG), for example, is commonly used in semiconductor device fabrication, where electrical circuits for the sensor are implemented, and may be similarly used. The glass may also include any well-known or proprietary blends of dielectric glasses that are used in semiconductor device fabrication.

In both embodiments, a glass layer structure may be initially provided. For example, a 10 μm layer of glass may be formed on the top of a 500 μm thick crystalline silicon (Si) substrate. The glass layer may be formed in one or more layers, with each layer being deposited using a plasma enhanced chemical vapor deposition (PECVD) process or other deposition technique. Electrical interconnects or other circuitry may be formed in the substrate and glass layer as known in the art. In some implementations, the glass layer structure may be fabricated separately.

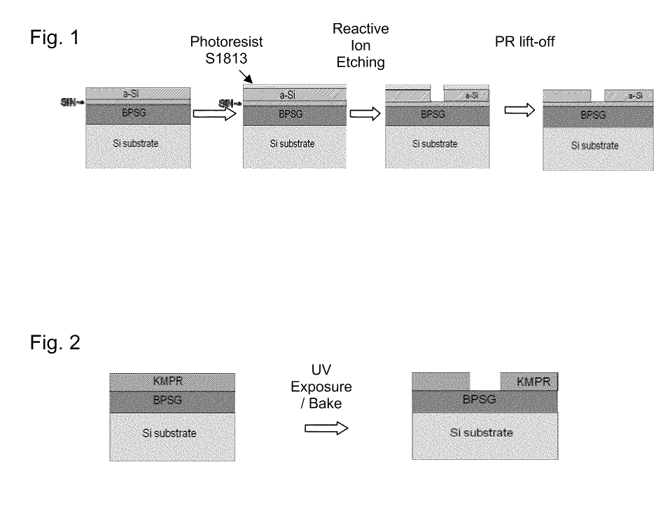

FIG. 1 illustrates an exemplary fabrication process for forming a silicon (Si) etch mask according to an embodiment.

Approximately a 1.5-2.5 μm thick layer of amorphous silicon (a-Si) may be formed on top of the glass layer. The glass layer may be, for instance, a part of a glass layer structure (as discussed above). In one implementation, the amorphous silicon may be deposited using a PECVD process at 200° C.

Before depositing the amorphous silicon, a thin sacrificial layer of nitride or the like, may optionally be deposited on top of the glass layer first. This thin layer helps to facilitate the lift-off process of the Si etch mask from the subsequently-etched glass layer with minimal damage to the glass layer. The thin layer may be, for example, approximately 50-200 nm of silicon nitride (SiN).

A photoresist may then be deposited on the amorphous silicon layer which will be used to pattern the Si etch mask. The photoresist, for example, may be a Shipley 1813 photoresist approximately 1-2 μm in thickness, although, other types and/or thicknesses of photoresist could be similarly used. In order to help promote adhesion of the photoresist to the glass layer, a 10 nm layer of hexamethyldisilazane (HMDS) or other adhesion promoter may, in some instances, first be applied to glass layer (or the sacrificial silicon nitride layer) before depositing the amorphous silicon.

The photoresist is then exposed to a pattern using contact optical lithography. The pattern defines the features which are to be subsequently formed in the glass layer. The photoresist patterning may be performed using vacuum contact or hard contact lithography, or other patterning process. For example, a Suss MicroTec AG MA6 mask aligner system may be used to expose the photoresist.

The exposed photoresist is then developed. A MF319 developer or similar developer agent might be used. After developing, the photoresist is patterned and ready for etching.

Next, an etching process is performed to form the pattern in the amorphous silicon layer. For example, reactive ion etching (RIE) technology may be employed. In one implementation, an inductively coupled plasma reactive ion etching (ICP RIE) tool manufactured by Surface Technology Systems might be used. In order to etch the amorphous silicon through the photoresist mask, reactive etching agents, such as sulfur hexafluoride (SF₆) and/or octafluorocyclobutane (C₄F₈) gases, can be introduced into the reaction chamber to provide to provide anisotropic and vertical sidewall etching of the amorphous silicon.

A suitable lift-off process may then be used to remove the photoresist from the amorphous silicon layer. For instance, the photoresist may be dissolved by acetone. Although, it will be appreciated that other lift-off techniques may similarly be used. The silicon etch mask is now fully patterned and is ready to be used for the etching of light pipes.

Subsequently, an etching process may be used to etch one or more features into the dielectric glass layer, which is discussed further below.

FIG. 2 illustrates an exemplary fabrication process for forming a photoresist etch mask in accordance with an embodiment;

First, a photoresist etch mask is formed on top of the glass layer structure, which include a glass layer and silicon substrate. For instance, the photoresist may be a MicroChem KMPR® 1005 negative photoresist approximately 5-7 μm in thickness formed on the glass layer using a spin-coating process. A 5-minute soft bake at 100° C. may optionally be performed to drive off excess solvent.

Next, the photoresist may be patterned by exposing it to suitable radiation. For example, using a PL-360LP Omega Optical filter and a Suss MicroTec AG MA6 mask aligner system, the coated substrate may be exposed to ultraviolet (UV) radiation having a wavelength between about 350-400 nm.

After exposing the photoresist, a post exposure bake may be performed for 1 minute at 100° C. to crosslink the polymer. The exposed photoresist mask is then developed. A suitable developer, such as SU-8 developer, may be used. Since the photoresist serves directly as the etch mask for the glass underlayer, the fabrication process of a photoresist etch mask may be simpler, in some regards, than that of the amorphous silicon etch mask of an embodiment.

Next, a suitable etching process may be used to etch one or more features, in the glass layer, as further discussed below.

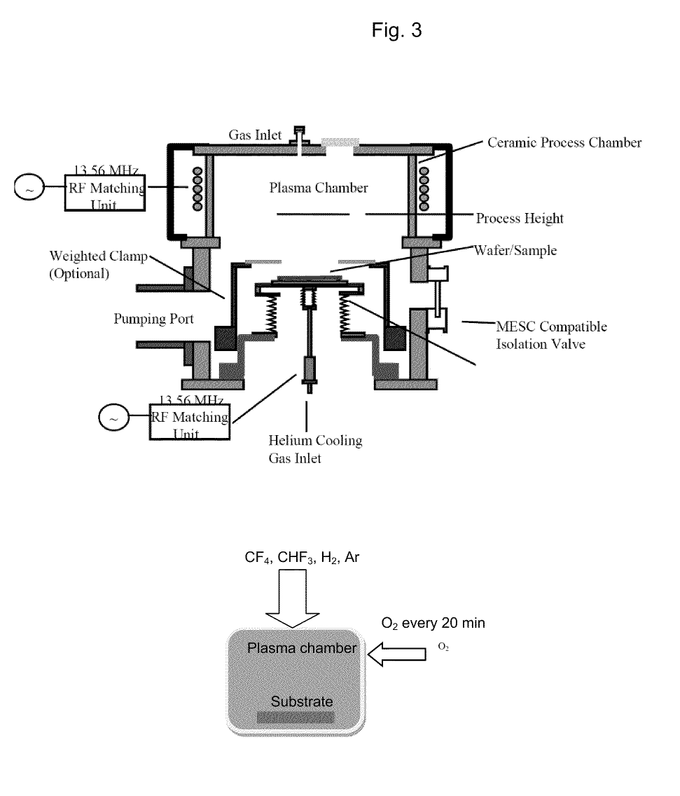

FIG. 3 shows a schematic of one exemplary reactive ion etching (RIE) system which may be used in accordance with the embodiments to form a feature.

The etching system generally includes a plasma chamber, where etching of the glass layer is performed. The glass layer having an etch mask, according to an embodiment, may be located in the process chamber. The process chamber may be a ceramic process chamber.

The glass layer may be placed first on top of a substrate holder (or platen). For instance, the glass layer may be located inside the chamber through a sealable entry port or door provided in the chamber.

The substrate holder may be raised and/or lowered with respect to the chamber using a temperature controlled bellows arrangement that forms a sealed electrode. In some implementations, the glass layer (or glass layer structure) may be clamped electrostatically and/or mechanically to the substrate holder. The temperature of the substrate during processing may be maintained at substantially a predetermined temperature, for example, less than about 80° C., by helium backcooling. The substrate holder may be raised such that the top surface of the glass layer comes to bear against an optional weighted clamp. Together the substrate holder and the clamp, securing the glass layer, may be raised to a process height position within the plasma chamber.

A pumping port may be used to evacuate the chamber. One or more gases, including reactant gases, may then be introduced into the chamber though the gas inlet to become plasma.

The plasma may be generated, for example, using a 1 kW 13.56 MHz radio frequency (RF) generator (coil power). In addition, the substrate holder may be provided with an additional phase-matching 13.56 MHz RF generator (platen power). Accordingly, this enables independent bias control of the glass layer.

The various parameters of the etching may be controlled by suitable control system (not shown). The control system may include hardware, software (firmware), or a combination thereof. For example, the control system may include a computer incorporated within or otherwise associated with the etching system. In particular, the control system is configured to control the process recipe, the flow rate of reactant gases, plasma generation, and ramp rates, in accordance with one or more embodiments disclosed herein.

Once the glass layer is loaded into the etching chamber, the chamber may be evacuated and one or more gases, including reactant gases, may be introduced into the etching chamber. An electromagnetic field, generated by two separate RF biases, is applied to the substrate or the glass layer, to form a plasma. A process recipe may include, among other things, RF biases, chamber pressure, the particular gases supplied, flow rates, timing, temperature, etc. By adjusting one or more or these parameters, controlled etching of the glass layer may be achieved using the etching system.

In one embodiment, an inductively coupled plasma reactive ion etching (ICP RIE) tool, manufactured by Surface Technology Systems PLC may be modified for use. Such ICP system provides a high density source of ions which increases the etch rate, whereas the separate RF bias is applied to the substrate to create directional electric fields near the substrate to achieve more anisotropic etch profiles.

FIG. 3(a) shows a schematic of the etching gases that may be supplied to the etching system. The reactant gases may include one or more fluorocarbon gases, such as tetrafluoromethane (CF₄) and/or fluoroform (CHF₃), and/or hydrogen (H₂). Additional gases, such as argon (Ar) and oxygen (O₂), may be introduced into the etching chamber. The pressure of the chamber, and the RF biases are calibrated to achieve the desired anisotropic etch profile and etch rate.

Two sets of samples were prepared by the inventors using a reactive ion etching (RIE) process: one set using the Si etch mask according to an embodiment, and the other with a photoresist etch mask according to an embodiment.

The inventors performed “design of experiments,” using a commercial software package, Design-Expert®, produced by State-Ease Inc. This technique helps plan and conduct experiments and analyze the resulting data so that valid and objective conclusions can be obtained. The goals of the experiments were to ensure (1) a high selectivity (i.e., the rate at which the glass layer is etched relative to the etch mask); and (2) a high etch rate of the glass layer; and (3) high verticality of the sidewalls of the features.

A set of 12 experiments were preformed by the inventors using various parameters to determine the most influential parameters on the three primary objectives. The parameters considered included, among others, the etching chamber pressure, temperature, etchant gases, and flow rates of various etchant agents. Some of the etching gases considered included CF₄, CHF₃, and H₂.

The inventors determined that the selectivity rate can be significantly improved by introducing hydrogen (H₂) with fluorine-based gases, such as CF₄ and/or CHF₃. Adding H₂ lowers the concentration of free fluorine radicals as a result of HF formation, reducing precursors of polymeric fluorocarbon. The excess formation of hydrocarbon polymers provide a coating to the sidewalls as a passivation layer, thus promoting anisotropic etching.

However, an excessive passivation polymer layer could potentially produce micro-masking effects and is difficult to remove in narrow and high aspect ratio features. The inventors further determined that the addition of oxygen (O₂) gas may effectively remove the formation of micro-masked “grass” features on the sample, however O₂ gas destroys the etch mask and lowers the selectivity rate. After one etchant recipe was obtained from the design of experiments technique, a series of experiments were carried out to optimize the recipe to obtain high aspect ratio vertical sidewalls in the etching process.

One optimized recipe for etching the Si etch mask according to an embodiment is provided in Table 1, below.

TABLE 1

| Gas | Flow Rate (sccm) |
|---|---|
| CF₄ | 2-5 |
| CHF₃ | 50 or greater |
| H₂ | 25 or greater |
| Ar | 5-7 |
| O₂ | 7-9 |
| | (5 min for every 20 |
| | minutes of etching) |

A radiofrequency (RF) energy source is used to activate the fluorine-based gases which act as etchants. The RF energy ionizes the gas and forms the etching plasma, which reacts with the wafers to form volatile products which are pumped away. To promote anisotropy etching, argon (Ar) gas may be introduced to perform physical bombardment on the etching surface. The 13.56 MHz RF coil and platen power may be set to 600 W and 100 W, respectively.

The chamber pressure may be maintained at a low pressure of about 2 mTorr. With the processing parameters listed in Table 1, the resulting selectivity rate may be greater than 6.5:1. The BPSG etching rate was found to be approximately 200 nm/min, and sidewall surface roughness (σ_{RMS}) was determined to be approximately 2 to 10 nm.

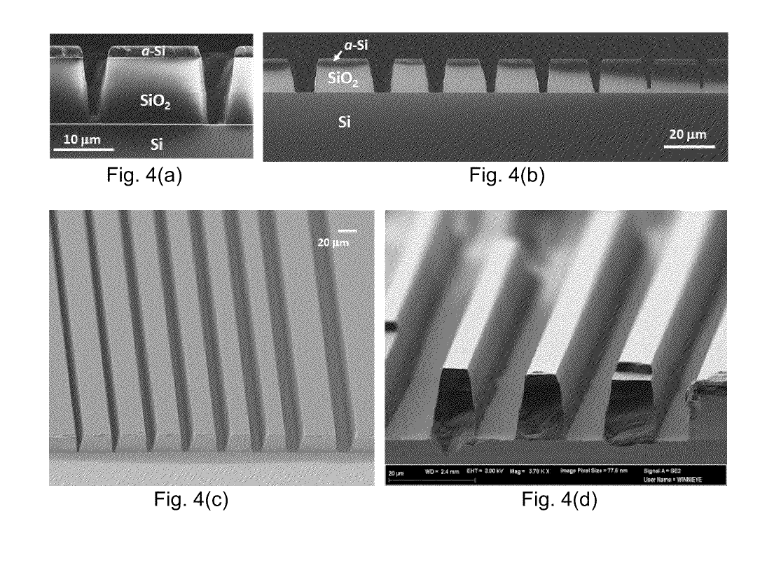

FIGS. 4(a)-(d) are scanning electron microscope (SEM) images showing the cross-sections of the high aspect ratio vias that were produced using a Si etch mask according to an embodiment.

FIG. 4(c)-(d) show the topographic views of the etched vias that were produced. A via that was produced by an embodiment demonstrated a 7.2:1 aspect ratio with a 87.40 sidewall angle. Here the etch depth is around 10 μm.

In some implementations, an aspect ratio dependent etch (ARDE) process might also be performed which results in narrow openings and a shallower etch.

One optimized recipe for etching the photoresist etch mask according to an embodiment is provided in Table 2, below.

TABLE 2

| Gas | Flow Rate (sccm) |
|---|---|
| CF₄ | 2-5 |
| CHF₃ | 50 |
| H₂ | 25 |
| Ar | 5-7 |
| O₂ | 0 |

The chamber pressure may be maintained at a pressure of about 2 mtorr and operated at a RF Power of about 600 W for the coil and 125 W for the platen, respectively. The inventors determined that oxygen gas lowers the selectivity rate significantly for the photoresist etch mask fabrication process. Thus, oxygen gas could be omitted altogether from the process recipe when etching the photoresist etch mask according to an embodiment.

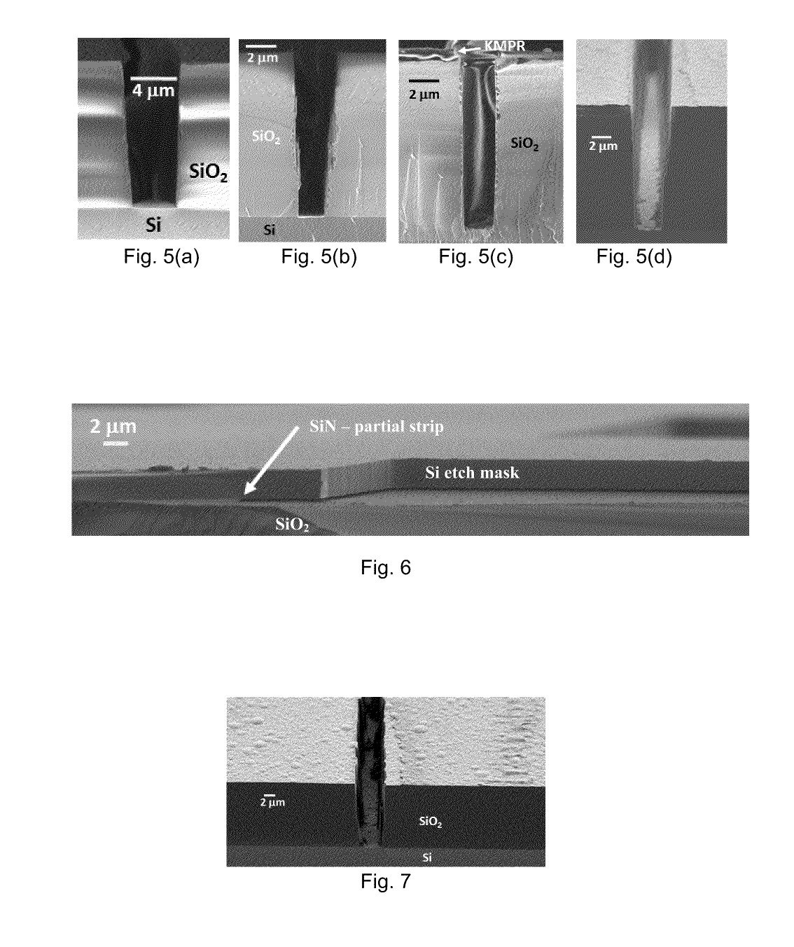

FIGS. 5(a)-(d) are SEM images showing high aspect ratio vias that were produced using a photoresist etch mask according to an embodiment. A via produced by an embodiment demonstrated a 6.7:1 aspect ratio with a 89.5° sidewall angle. Using these parameters, the resulting selectivity rate was determined to be greater than 3.0. The etching rate for BPSG was found to be approximately 200 nm/min, and the sidewall roughness to be on the order of a few nanometers.

Compared with the etched samples shown in FIGS. 4(a)-(d), which used the silicon etch mask of an embodiment, the samples with the photoresist etch mask showed, in some regards, improved vertical sidewalls and cleaner finishes at the bottom of the etched vias.

After etching the vias, the etch masks, according to the embodiments herein, may be subsequently removed from the glass layer.

FIG. 6 is a SEM image showing the partial lift-off the Si etch mask in accordance with an embodiment.

Since the bottom of the etched vias is silicon, the lift-off method of the silicon etch mask should not be invasive to silicon. Thus, as discussed above, a thin sacrificial layer of nitride may be introduced underneath the silicon etch mask, as shown in FIG. 1. For example, a 50 nm thick silicon nitride (SiN) layer may be deposited by a PECVD process, prior to the deposition of the silicon etch mask.

A nitride wet strip process may be performed to remove the Si etch mask from the glass layer, for example, using hot phosphoric acid heated to about 155° C. The etch rate of SiN was determined to be less than 2 nm/min. Although, it was determined that if the lift-off process involves lateral wet-etching of SiN, that the lateral etch rate may be much higher than 2 nm/min. Since SiN and SiO₂ use similar etchant agents, experiments showed no significant difference in the etch rate of both materials using the above-disclosed etch recipes (see Tables 1 and 2).

FIG. 7 is a SEM image showing a topographic view of a sample after the removal of the photoresist etch mask in accordance with an embodiment.

The photoresist etch mask, such as KMPR® used in the sample, may be dissolved using MicroChem's Remover PG (NMP) by immersing it in a heated Remover PG solution at 80° C. for about 20 minutes.

Compared with the lift-off process for the Si etch mask of an embodiment, the photoresist etch mask may be, in some regards, easier to work with.

In some embodiments, the etched vias may be subsequently filled with a light guiding material to provide light pipes. For high aspect ratio structures to be useful for vertical interconnect and waveguiding applications, the vias may be filled with a material that has a refractive index higher than that of the glass layer. For BPSG, the refractive index should be greater than 1.45. In one implementation, silicon nitride (SiN) may be used, having a refractive index from about 1.8 to 2.2. Not only does this particular nitride have a high refractive index, but it can be deposited using gas agents and provides a good filling factor for high aspect ratio features. Other high refractive index material could similarly be used which are transparent at a desired wavelength.

In some implementations, a metal coating or cladding may be formed on the inside walls of the vias before depositing the high refractive material. The metal coating helps to improve the light confinement properties of the light pipe. A thin layer on the order of tens of nanometer of any metal material, such as aluminum, should be sufficient.

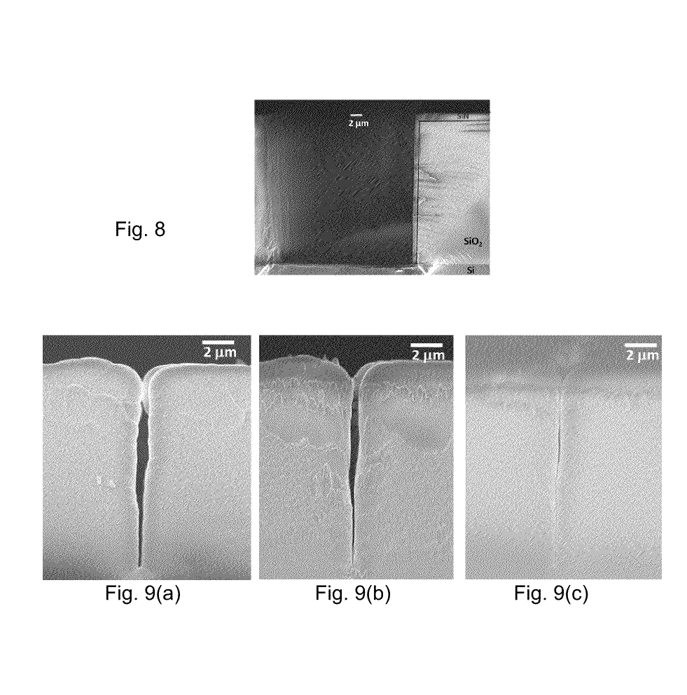

FIG. 8 shows a SEM image of the cross-section of a partial silicon nitride filling of a via. A 500 nm thick silicon nitride layer was deposited by a PECVD process to uniformly cover the sidewalls of the etched vias. The ratio of the top coating to the sidewall coverage was observed to be approximately 0.68:1.

However, as the thickness of silicon nitride increases, the opening has a tendency to “close up” near its top. This is shown in the SEM image of FIG. 9(a). If this occurs, a planarization procedure may be performed to remove the excess top coating of the SiN at the top of the vias. The planarization procedure may be a RIE process. In order to preserve the sidewall coverage, chamber pressure for the RIE was set high, for example, at about 20 mTorr. FIG. 9(b) shows improvement in the opening cross-section, where two corners of the upper portions of a via had been rounded off by subsequent RIE etching.

Additional deposition of the SiN may be performed, in one or more iterations, to further fill the via, if needed. FIG. 9(c) shows the via after an additional 30 minutes of PECVD deposition following the planarization step. For a substantially complete fill of the via, a slow deposition could be performed, for example, using a Savannah Atomic Layer Deposition (ALD) system.

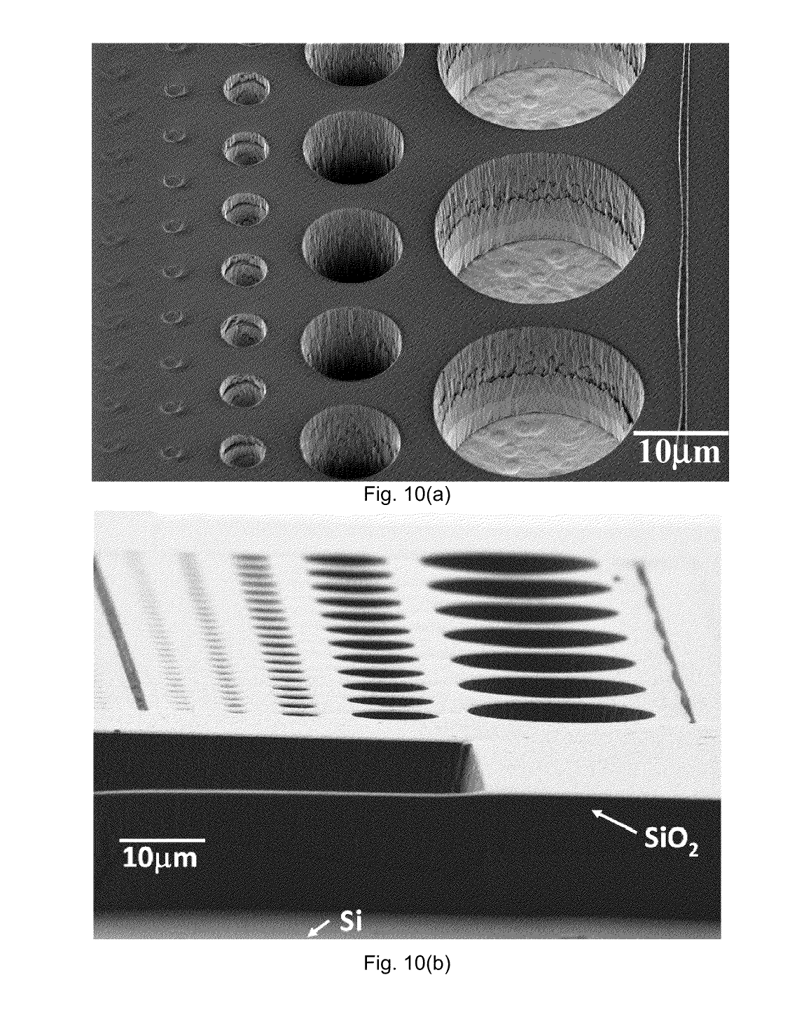

FIGS. 10(a) and 10(b) are SEM images showing circular vias which were fabricated in a SiO₂ glass layer in accordance with an embodiment. The circular via fabricated was approximately 2.4 μm in diameter and 13.88 μm in depth, yielding an aspect ratio of about 5.8:1. In other embodiment, using a SiO₂ glass layer having a greater depth, it would be possible to make a circular via having a higher aspect ratio of 7:1, 8:1, 9:1 or 10:1, for example.

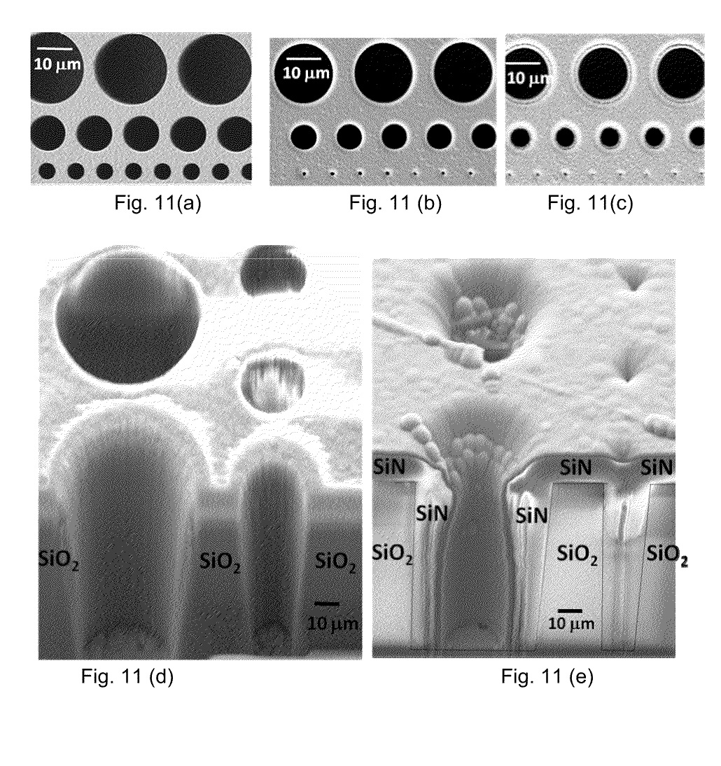

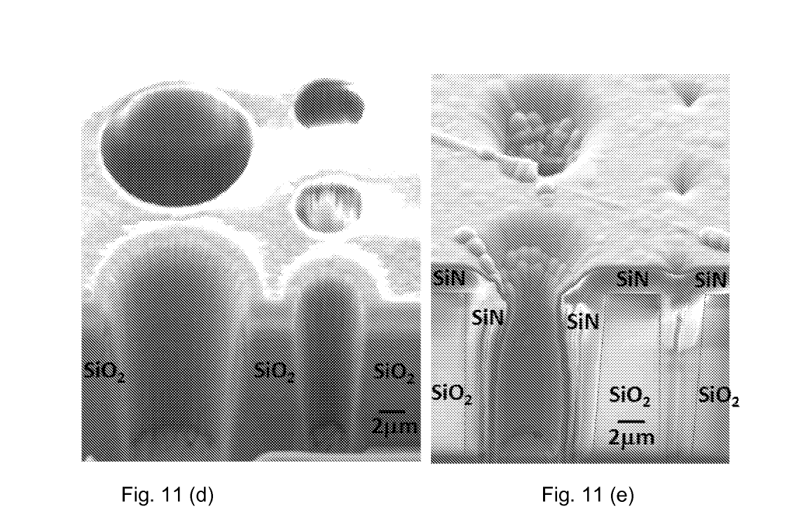

FIG. 11(a)-11(c) show the SEM images of the top view of the silicon nitride (SiN) filling of circular pipes. Similar filling process as illustrated in FIGS. 9(a)-9(c) was adapted here. FIG. 11(a) shows the light pipe prior to SiN PECVD deposition. After 3 hours of SiN PECVD deposition, the circular pipes were filled partially, with about 3 μm reduction in the diameters of the circular openings, as illustrated in FIG. 11(b). As the thickness of SiN increases, the opening has a tendency to “close up” near its top. A planarization step may be performed to remove the excess top coating of the SiN. The planarization procedure may be a RIE process. In order to preserve the sidewall coverage, chamber pressure for the RIE was set high, for example, at about 20 mtorr. After 10 minutes of planarization step, an additional 50 minutes of SiN PECVD deposition was performed. FIG. 11(c) shows the SEM image of the top view of the partially filled circular pipes at the end of the PECVD deposition process.

Additional deposition of the SiN may be performed, in one or more iterations, to further fill the via, if needed. FIGS. 11(d) and 11(e) compare the cross-sections of the circular pipes before and after the SiN PECVD filling process. The SEM images show that circular pipes with a diameter of 3.4 μm (located at the right side of the images) were completely filled with SiN, while the larger 10 μm circular pipes were partially filled. For a substantially complete fill of the via, a slow deposition could be performed, for example, using a Savannah Atomic Layer Deposition (ALD) system.

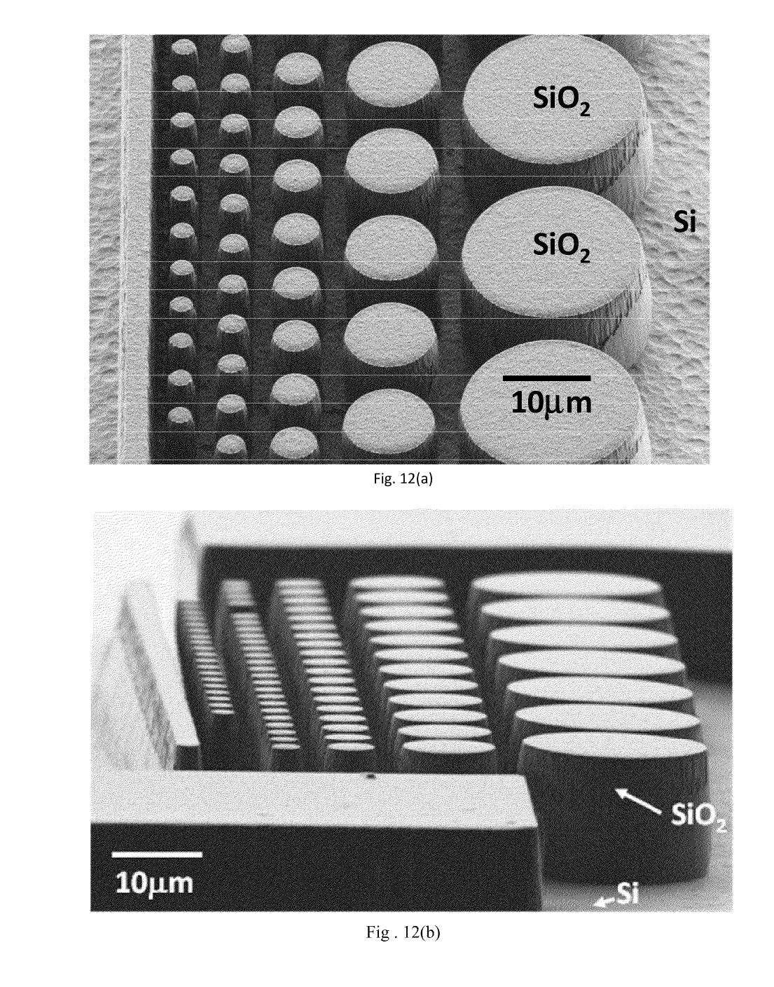

FIGS. 12(a) and 12(b) are SEM images showing pillars which were fabricated in a SiO₂ glass layer in accordance with an embodiment. The feature was approximately 2.4 μm in diameter and 13.88 μm in height, yielding an aspect ratio of about 5.8:1. In other other embodiment, using a SiO₂ glass layer having a greater depth, it would be possible to make a pillar having a higher aspect ratio of 7:1, 8:1, 9:1 or 10:1, for example.

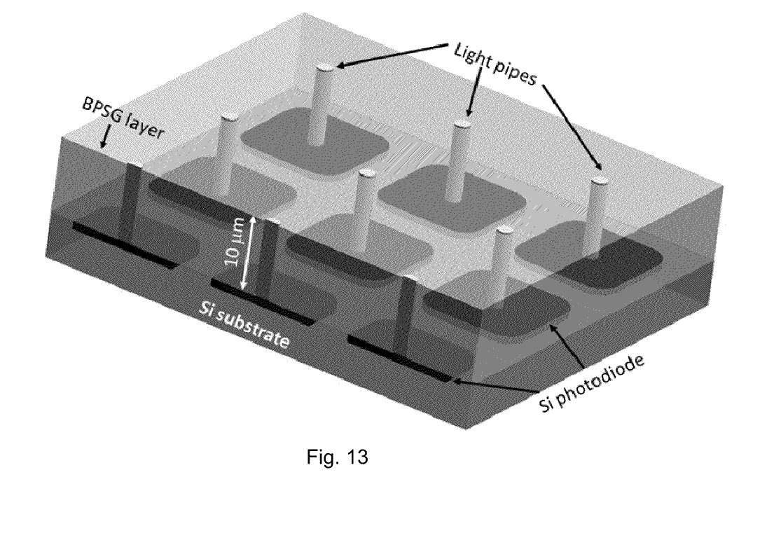

FIG. 13 shows an isometric view of an exemplary image sensor device formed in accordance with an embodiment.

The image sensor device may include an array of photodiodes formed on a silicon substrate. While the illustrated embodiment shows a 3×3 array, it will be appreciated that generally such devices will be fabricated to have in excess of 1 million photodiodes, in a (Cartesian) square grid. Each photodiode forms a pixel for the image sensor device.

A borophosphosilicate glass (BPSG) layer is formed over the silicon substrate. A plurality of vias defining light pipes may be formed in the glass layer according to the embodiments herein, as discussed above.

The light pipes may have a circular cross-section, and may be approximately 1.5 μm in diameter and 10 μm in height. A high refractive index material, such as silicon nitride, is filled in each of the vias to form the light pipes.

The foregoing detailed description has set forth various embodiments of the devices and/or processes by the use of diagrams, flowcharts, and/or examples. Insofar as such diagrams, flowcharts, and/or examples contain one or more functions and/or operations, it will be understood by those within the art that each function and/or operation within such diagrams, flowcharts, or examples can be implemented, individually and/or collectively, by a wide range of hardware, software, firmware, or virtually any combination thereof.

In one embodiment, several portions of the subject matter described herein may be implemented by a control system, such as Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs having computer-executable instructions or code running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one skilled in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of computer-readable medium used to actually carry out the distribution.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

All references, including but not limited to patents, patent applications, and non-patent literature are hereby incorporated by reference herein in their entirety.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for fabricating a feature in a glass layer comprising:
forming a silicon etch mask or a photoresist etch mask on the glass layer; and
etching a sidewall in the glass layer to form a feature having a depth or a height and a width,
wherein the glass layer has a thickness of about 10 μm or more and the feature has an aspect ratio of at least about 2.8:1, the aspect ratio being the ratio of the depth or the height to the width.

2. The method according to claim 1, wherein the glass comprises silica, fused quartz, silicon dioxide (SiO₂) or borophosphosilicate glass.

3. (canceled)

4. The method according to claim 1, wherein the feature is a via, and further comprises filing the via with a high refractive index material.

5. The method according to claim 4, wherein the high refractive index material comprises silicon nitride (SiN).

6. The method according to claim 4, further comprising:
performing a planarization process to remove an excess top coating of the high refractive index material; and
optionally, depositing an additional high refractive index material in the via.

7. The method according to claim 1, wherein the feature has a sidewall having a sidewall angle of about at least 87°.

8. The method according to claim 1, wherein the etching comprises reactive ion etching (RIE) comprising flowing the one or more gases.

9. The method according to claim 1, wherein the feature has a sidewall having a sidewall surface roughness (σ_{RMS}) of about 10 nm or less.

10. The method according to claim 1, wherein the feature is one of a via or a pillar.

11. The method according to claim 1, wherein forming the silicon etch mask comprises depositing approximately a 1.5 to 2.5 μm thick amorphous silicon layer on the glass layer.

12. The method according to claim 11, further comprising depositing approximately a 50 to 200 nm layer of silicon nitride (SiN) on the glass layer before depositing the amorphous silicon layer.

13. The method according to claim 11, further comprising depositing approximately a 5 to 7 μm photoresist layer on the amorphous silicon etch mask.

14. The method according to claim 13, further comprising depositing approximately a 5 to 10 nm layer of hexamethyldisilazane (HMDS) on the amorphous silicon etch mask before depositing the photoresist layer.

15. The method according to claim 8, wherein the flowing the one or more gases comprises:
CF₄ at approximately 2 to 5 sccm;
CHF₃ at approximately 50 sccm or higher;
H₂ at approximately 25 sccm or higher;
Ar at approximately 5 to 7 sccm; and
O₂ at approximately 7 to 9 sccm,
each at a pressure of approximately 1.9 to 2.5 mTorr.

16. The method according to claim 15, wherein the O₂ is periodically flowed for 5 minutes during said gas flowing approximately every 20 minutes.

17. The method according to claim 1, wherein forming the photoresist etch mask comprises forming a negative photoresist etch mask.

18. The method according to claim 1, wherein the photoresist etch mask is approximately 5 to 7 μm thick.

19. The method according to claim 8, wherein the flowing the one or more gases comprises:
CF₄ at approximately 2 to 5 sccm;
CHF₃ at approximately 50 sccm;
H₂ at approximately 25 sccm;
Ar at approximately 5 to 7 sccm; and
O₂ at approximately 0 sccm;
each at a pressure of approximately 1.9 to 2.5 mTorr.

20. The method of claim 1, wherein the feature has an aspect ratio of at least about 5.8:1.

21. An device comprising:
a glass layer having a feature having a depth or a height and a width, wherein the feature has a sidewall with a sidewall angle of at least about 87° and an aspect ratio of at least about 2.5:1, the aspect ratio being the ratio of the depth or the height to the width.

22. The device according to claim 21, wherein the sidewall has a surface roughness (σ_{RMS}) of about 10 nm or less.

23. The device according to claim 21, wherein the aspect ratio is about at least 7.2:1 and the sidewall angle is about at least 87.4°.

24. The device according to claim 21, wherein the aspect ratio is about at least 6.7:1 and the sidewall angle is about at least 89.5°.

25. The device according to claim 21, wherein the glass comprises silica, fused quartz, silicon dioxide (SiO2) or borophosphosilicate glass.

26. The device according to claim 21, wherein the feature is one of a via or a pillar.

27. The device according to claim 21, wherein the feature is a via comprising a high refractive index material.

28. The device of claim 27, wherein the device is an optical light pipe.

29. The device of claim 21, wherein the glass layer has a thickness of about 10 μm or more.

30. The device of claim 21, wherein the aspect ratio is at least 3:1.
